(19) United States
(12) Patent Application Publication
(10) Pub. No.: US 2018/0233064 A1
(43) Pub. Date: Aug. 16, 2018

(54) NUTRITION SCORING SYSTEM

(71) Applicant: NUTRILYZE LLC, Kansas City, MO (US)

(72) Inventors: Joseph DUNN, Kansas City, MO (US); Joseph T. WHITAKER, Napa, CA (US)

(73) Assignee: NUTRILYZE LLC

(21) Appl. No.: 15/894,695

(22) Filed: Feb. 12, 2018

Related U.S. Application Data
(60) Provisional application No. 62/458,128, filed on Feb. 13, 2017.

(51) Int. Cl. G09B 19/00; G06F 17/30

(52) U.S. Cl. CPC G09B 19/0092; G06F 17/3053; G06F 17/30867

(57) ABSTRACT

Method for determining a personalized nutrition score for a given meal for a particular user. Traditionally, users choose meals in an ad-hoc fashion, based on dimly remembered guidance aimed at an average person. However, dietary needs vary greatly from person-to-person, based on age, sex, weight, activity level, weight-loss goals, genetics, and many other factors. Furthermore, published nutritional information for meals or individual foods are also based on average portion and serving sizes, and may not accurately reflect the amount consumed by a user. Thus, embodiments of the invention evaluate a potential meal for a user and determine a score representing the nutritional benefits of that meal for the particular user.

### RELATED APPLICATIONS

This non-provisional patent application claims priority benefit, with regard to all common subject matter, of earlier-filed U.S. Provisional Patent Application No. 62/458,128 filed Feb. 13, 2017 and entitled NUTRITION SCORING SYSTEM. The identified earlier-filed provisional patent application is hereby incorporated by reference in its entirety into the present application.

### BACKGROUND

### 1. Field

Embodiments of the invention generally relate to nutrition science and, more particularly, to a system for evaluating a potential meal for a user and determining a score representing the nutritional benefits of that meal for the particular user.

### 2. Related Art

Traditionally, users choose meals in an ad-hoc fashion, based on dimly remembered guidance aimed at an average person. However, dietary needs vary greatly from one person to another, based on factors such as age, sex, weight, activity level, weight-loss goals, eating habits, dietary restrictions, dietary preferences, genetics, and many other factors. Furthermore, published nutritional information for meals or individual foods are also based on average portion and serving sizes and may not accurately reflect the amount consumed by a user. Finally, potential meals that are beneficial in one nutritional aspect (for example, high in vitamins) may be harmful in another nutritional aspect (for example, high in saturated fats). As such, there is a need for a system that can automatically analyze a potential meal along a number of axes and calculate a single, easily comprehensible score for the potential meal for the particular user.

### SUMMARY

Embodiments of the invention address the above-described need by providing for a system that automatically determines a user's nutritional needs and scores meals based on their nutritional content as compared to the user's needs.

In particular, in a first embodiment, the invention includes a method of determining a user-specific nutrition score for a meal, comprising the steps of determining a plurality of baseline recommended intake values for a plurality of nutrients, wherein the plurality of nutrients includes a plurality of macronutrients and a plurality of micronutrients, adjusting the plurality of baseline recommended intake values based on demographic information for the user to obtain a respective plurality of custom recommended intake values, further adjusting the plurality of custom recommended intake values based on biometric data for the user to obtain a respective plurality of dynamic recommended intake values, wherein the biometric data is obtained from a peripheral device; determining, for a potential meal, nutrient content values for at least a portion of the plurality of nutrients, calculating, based on the plurality of nutrient content values and the plurality of dynamic recommended intake values, a macronutrient sufficiency score, a micronutrient sufficiency score, and a detriment score, and calculating a meal score based at least in part on the macronutrient sufficiency score, the micronutrient sufficiency score, and the detriment score.

In a second embodiment, the invention includes a system for determining a user-specific nutrition score for a meal, comprising the steps of determining a plurality of baseline recommended intake values for a plurality of nutrients, wherein the plurality of nutrients includes a plurality of macronutrients and a plurality of micronutrients, adjusting the plurality of baseline recommended intake values based on demographic information for the user to obtain a respective plurality of custom recommended intake values, further adjusting the plurality of custom recommended intake values based on biometric data for the user to obtain a respective plurality of dynamic recommended intake values, wherein the biometric data is received from a first peripheral device associated with the user, receiving information associated with a potential meal, wherein the information associated with the potential meal is based at least in part on information received from a second peripheral device, determining, for a potential meal, nutrient content values for at least a portion of the plurality of nutrients, calculating, based on the plurality of nutrient content values and the plurality of dynamic recommended intake values, a macronutrient sufficiency score, a micronutrient sufficiency score, and a detriment score, and calculating a meal score based at least in part on the macronutrient sufficiency score, the micronutrient sufficiency score, and the detriment score.

In a third embodiment, the invention includes one or more computer-readable media storing computer-executable instructions, when executed by a computer perform a method of determining a user-specific nutrition score for a meal, the method comprising the steps of determining a plurality of baseline recommended intake values for a plurality of nutrients, wherein the plurality of nutrients includes a plurality of macronutrients and a plurality of micronutrients, adjusting the plurality of baseline recommended intake values based on demographic information for the user to obtain a respective plurality of custom recommended intake values, further adjusting the plurality of custom recommended intake values based on biometric data for the user to obtain a respective plurality of dynamic recommended intake values, wherein the biometric data is received from a peripheral device, receiving information associated with a potential meal, determining, for a potential meal, using the information associated with the potential meal, nutrient content values for at least a portion of the plurality of nutrients, calculating, based on the plurality of nutrient content values and the plurality of dynamic recommended intake values, a macronutrient sufficiency score, a micronutrient sufficiency score, and a detriment score, and calculating a meal score based at least in part on the macronutrient sufficiency score, the micronutrient sufficiency score, and the detriment score.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 depicts an exemplary hardware platform for certain embodiments of the invention;

FIG. 2 depicts an exemplary nutrient chart;

FIG. 3 depicts an exemplary graphical user interface presenting a user profile in embodiments of the invention;

FIG. 4 depicts an exemplary embodiment of a meal ingredient list;

FIG. 5 depicts exemplary nutrient and detriment scoring table presented on a graphical user interface in embodiments of the invention;

FIG. 6 depicts an exemplary meal imaging in embodiments of the invention;

FIG. 7 depicts an exemplary graphical user interface in embodiments of the invention;

FIG. 8 depicts an exemplary nutrients breakdown list presented on a graphical user interface in embodiments of the invention;

FIG. 9 depicts the exemplary nutrients breakdown of the embodiment depicted in FIG. 8;

FIG. 10 depicts an exemplary online meal ordering service accessible through a graphical user interface in embodiments of the invention;

FIG. 11 depicts exemplary devices and appliances associated with embodiments of the invention;

FIG. 12 depicts an exemplary graphical user interface accessing devices and appliances in embodiments of the invention;

FIG. 13 depicts an exemplary graphical user interface presenting meal options in embodiments of the invention;

FIG. 14 depicts an exemplary graphical user interface presenting nutrient and detriment information for a meal in embodiments of the invention;

FIG. 15 depicts a flowchart illustrating the operation of a method in accordance with an embodiment of the invention; and

The drawing figures do not limit the invention to the specific embodiments disclosed and described herein. The drawings are not necessarily to scale, emphasis instead being placed upon clearly illustrating the principles of the invention.

### DETAILED DESCRIPTION

At a high level, embodiments of the invention determine dynamically adjusted recommended intake values for various nutrients for a particular user based on a variety of demographic and biometric data for that user and then score potential meals based on their nutritional content as compared to the recommended intake values for those nutrients. By presenting simple metrics in an easily comprehensible form, the system makes it easier for users to make good nutrition decisions.

The subject matter of embodiments of the invention is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be obvious to one skilled in the art, and are intended to be captured within the scope of the claimed invention. Terms should not be interpreted as implying any particular ordering of various steps described unless the order of individual steps is explicitly described.

The following detailed description of embodiments of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of embodiments of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate reference to “one embodiment” “an embodiment”, or “embodiments” in this description do not necessarily refer to the same embodiment and are also not mutually exclusive unless so stated and/or except as will be readily apparent to those skilled in the art from the description. For example, a feature, structure, or act described in one embodiment may also be included in other embodiments, but is not necessarily included. Thus, the technology can include a variety of combinations and/or integrations of the embodiments described herein.

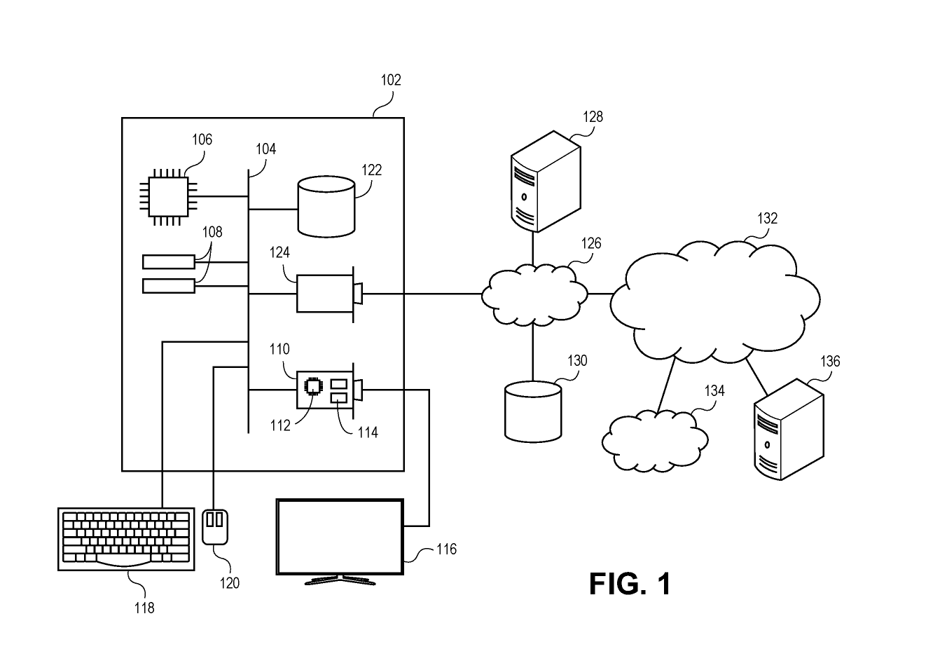

Turning first to FIG. 1, an exemplary hardware platform for certain embodiments of the invention is depicted. Computer 102 can be a desktop computer, a laptop computer, a server computer, smart exercise equipment or home appliances, a mobile device such as a smartphone or tablet, or any other form factor of general- or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple busses or components may communicate with each other directly. Connected to system bus 104 is central processing unit (CPU) 106. Also attached to system bus 104 are one or more random-access memory (RAM) modules 108. Also attached to system bus 104 is graphics card 110. In some embodiments, graphics card 104 may not be a physically separate card, but rather may be integrated into the motherboard or the CPU 106. In some embodiments, graphics card 110 has a separate graphics-processing unit (GPU) 112, which can be used for graphics processing or for general purpose computing (GPGPU). Also on graphics card 110 is GPU memory 114. Connected (directly or indirectly) to graphics card 110 is display 116 for user interaction. In some embodiments no display is present, while in others it is integrated into computer 102. Similarly, peripherals such as keyboard 118 and mouse 120 are connected to system bus 104. Like display 116, these peripherals may be integrated into computer 102 or absent. Also connected to system bus 104 is local storage 122, which may be any form of computer-readable media, and may be internally installed in computer 102 or externally and removeably attached.

Computer-readable media include both volatile and nonvolatile media, removable and non removable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-usable instructions, data structures, program modules, and other data representations.

Finally, network interface card (NIC) 124 is also attached to system bus 104 and allows computer 102 to communicate over a network such as network 126. NIC 124 can be any form of network interface known in the art, such as Ethernet, ATM, fiber, Bluetooth, or Wi-Fi (i.e., the IEEE 802.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Data stores can be local to a single computer such as computer 128, accessible on a local network such as local network 126, or remotely accessible over Internet 132. Local network 126 is in turn connected to Internet 132, which connects many networks such as local network 126, remote network 134 or directly attached computers such as computer 136. In some embodiments, computer 102 can itself be directly connected to Internet 132.

Embodiments of the invention may score meals, snacks, or any food based on nutritional value customized for a particular user. Create a customized meal-plan for a user may begin by creating a baseline nutrient profile. Broadly speaking, a nutrient profile includes target values for a plurality of nutrients. As it is used herein, the term “nutrient” includes any component of food that is absorbed or otherwise metabolized by a person who eats it. For example, nutrients include macronutrients (carbohydrates, protein, and fats), micronutrients (vitamins and minerals), water, amino acids, and dietary fiber. Nutrients may also be categorized hierarchically. For example, alpha-linoleic acid is one type of omega-3 fatty acid, which is in turn one type of unsaturated fat, which is one type of fat, which is in turn one type of caloric source. Thus, a dietary source of alpha-linoleic acid would count toward the target values for all nutrients above it in the hierarchy.

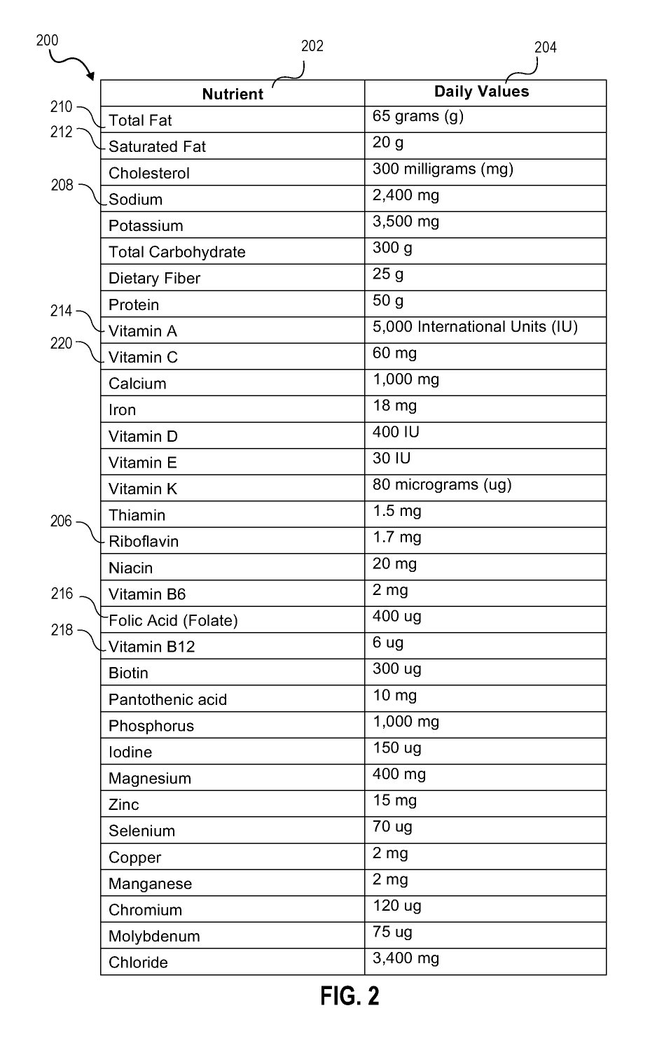

Target values may be determined from a variety of sources. For example, the United States Food and Drug Administration provides daily reference values for a variety of nutrients 202, as shown in the exemplary table 200 in FIG. 2. Target values for a nutrient 202 may be any constraint on the amount of the nutrient 202 that should be consumed. In embodiments, target values may be daily values 204 or daily recommended values. For example, the target values for vitamin B2 (Riboflavin) 206 may be 1.7 milligrams. Some nutrients 202 may have a maximum target value. For example, the target value for sodium 208 may be 2,400 milligrams. However, the target value may be assigned as a minimum of 2,300 milligrams depending on the source for the baseline nutrient profile 200. Some such nutrients 202 (such as trans fats or added sugars) may have a target value of zero, meaning that it is desirable to consume as little of that nutrient 202 as possible. Many nutrients 202 will have both an upper target value and a lower target value. For example, the target value for caloric sources may be between 2,400 and 2,600 calories. The type of target values may differ between levels in the nutrient hierarchy. For example, the target value for total fat 210 may be “between 50 and 70 grams total, no more than 20 grams of which should be saturated fats 212.” In some embodiments, target values are expressed on a daily basis. In other embodiments, target values are apportioned throughout the day. For example, the total target value for vitamin A 214 might be “5,000 International Units (IU) daily,” but (due to the limited rate at which vitamin A 214 can be absorbed) this might be broken down to “1,000 IU at breakfast, 2,000 IU at lunch, and 2,000 IU at dinner.” The baseline nutrient profile 200 may be a starting point for any user and may later be altered or customized based on user input, demographic shifts, medical studies, or any other information that may be relevant. Broadly speaking, target values are broadly applicable across all life stage groups, and may be adjusted, supplemented, or replaced based on user demographic data, as described below.

Continuing with the exemplary embodiment depicted in FIG. 2, once the baseline nutrient profile 200 for the user has been constructed, the baseline nutrient profile 200 may be adjusted based on user demographic data to create a custom user profile. The daily values 204 given in FIG. 2 provide normative values for an average person based on a daily caloric intake of 2,000 calories. As such, when calculating the target value for these nutrients 202, the daily values 204 may be scaled based on the target value for total caloric intake calculated for the user. The baseline nutrient profile 200 is exemplary only and the reference daily values 204 may also be derived from other sources. For example, the American Heart Organization and the American Medical Association also publish diet recommendations that may be used to supplement or replace the FDA's guidelines given above.

As described above, target values for each nutrient 202 may vary from user to user based on a wide variety of other factors. For example, total recommended caloric intake could vary based on the user's age, sex, current weight, weight-loss goals, activity levels, and genetic profile or weighted against a demographic mean. Other factors may also contribute to determine the target value for nutrients 202. For example, folic acid (vitamin B9) 216 may have a target value of “at least 400 micrograms” for most adults, but “at least 600 micrograms” for women who are pregnant or plan to become pregnant. Broadly, target values for each nutrient 202 may be adjusted based on any demographic attribute or combination of demographic attributes for the user. For example, if the user has a genetic condition that causes vitamin B12 218 to be absorbed inefficiently, then the target value for vitamin B12 218 can be increased accordingly.

In some embodiments, the daily values 202 from the baseline profile 200 may be replaced with values more specific to the individual. For example, the daily value 204 given above for Vitamin C 220 (across all life stage groups) is 60 mg. However, some or all nutrients 202 may be assigned either an Estimated Average Requirement (EAR) and Recommended Daily Allowance (RDA) or an Adequate Intake (Al) value for each life stage. Broadly speaking, the EAR and RDA are, respectively, essentially the median and 97.5th percentile, of the distribution of deficiency likelihoods for a given nutrient 202 and given life stage group. The Al is a single threshold value for a particular life stage group. Thus, in the example given above of Vitamin C 220, for men 31-50 years of age, the vitamin C EAR is 75 mg and the RDA is 90 mg, meaning 50% of men show signs of vitamin C deficiency when they consume an average of 75 mg of vitamin C 220 daily, and only 2.5% show signs of deficiency when consuming 90 mg per day on average. As such, in some embodiments of the invention, the target value may be calculated based on the RDA and EAR where it is available, falling back to the Al threshold if no RDA and EAR are available, with the DV as a final fallback if no more specific values are available. These amounts may still further be personalized to an individual user. For example, if the user has a genetic condition (as indicated by a DNA analysis or other test) that causes certain nutrients to be absorbed poorly, the target value may be increased to reflect this. Similarly, an analysis of the user's microbiome may indicate that certain foods or macronutrients are adsorbed more or less readily, and the contribution by those foods towards the target value can be adjusted accordingly.

One of skill in the art will appreciate that embodiments of the invention are not comparing the amount of nutrients 202 in a meal with a single target value to determine whether the user will be deficient in that nutrient 202 if they eat that meal, but rather examining the likelihood of deficiency if the user regularly consumes meals with the same density of that nutrient 202.

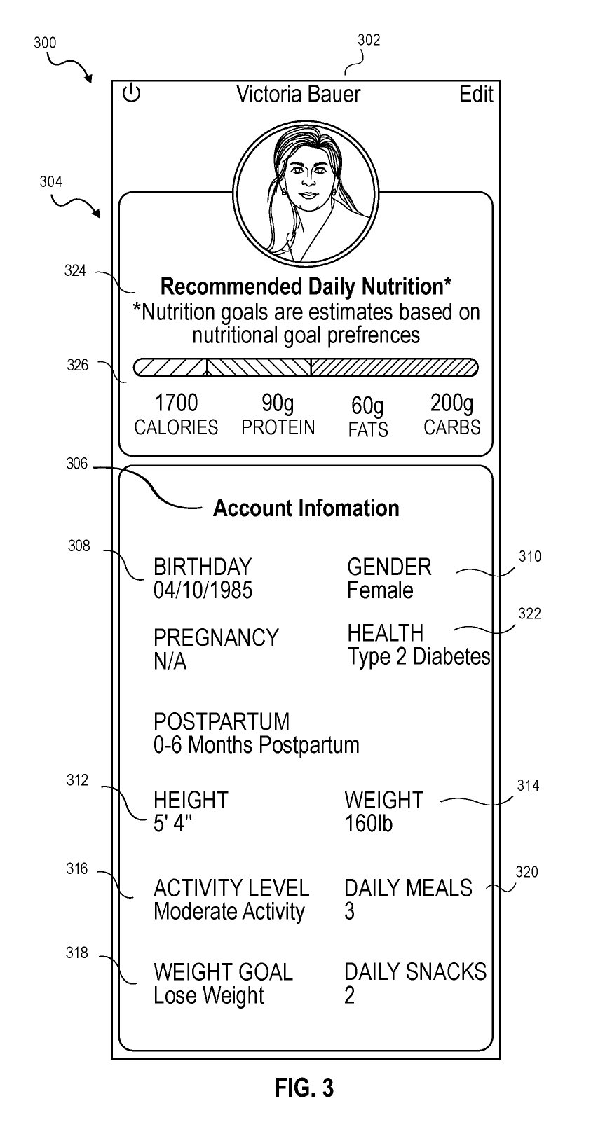

In an embodiment depicting an exemplary graphical user interface (GUI) 300 of the invention in FIG. 3, a user 302 Victoria Bauer may create a user profile 304. The user 302 may log onto a computer, smart phone, tablet, or any other device that may access the internet and support the GUI 300. The user 302 may answer questions related to demographic, medical history, family medical history, genetics, and any other information that may assist in determining a goal oriented, or health oriented, diet for user 302. The user 302 may answer questions or provide information necessary to create the user profile 304 that will enable the user access to, and the system to create the baseline profile and adjustments and customizations as described above.

The information provided by the user 302 in the user profile 304 may be listed under the account information header 306. The system may store user 302 demographic information such as birthday 308, gender 310, height 312, and weight 314. The system may also use activity data 316, goal oriented data 318, and food intake data 320. Medical information 322 may also be provided. For example, the user 302 is 0-6 months postpartum and has type 2 diabetes. This information may be necessary in providing a nutrient plan 324, or recommended daily nutrition plan, that meets the goal oriented data 318 of the user 302 but keeps glucose levels within a safe range based on the medical information 322. The nutrient plan 324 may also incorporate snacks and timing to regulate glucose while maintaining the goal oriented data 318, weight loss plan. For example, the nutrient plan 324 may incorporate a good mixture of protein, fat, and fiber. The user 302 may have an afternoon snack of yogurt and an evening snack of cranberries. These specific snacks may be built into the scoring with the understanding that these snacks may be necessary based on the dynamic condition of the user 302.

Though the nutrient plan 324 described above is tailored towards managing type 2 diabetes, a Person of skill in the art will appreciate that the plan may take into account many other types of medical conditions and the system may connect to many types of peripheral devices. For example, the user 302 may be allergic to tree nuts so no food containing tree nuts or any other known allergens are recommended by the system. The system may go a step further in detecting known allergens and connect to a peripheral device such as a allergen testing kit that may detect small amounts of allergens that may be harmful to the user 302. The system may warn the user 302 if such allergens are contained in the food thus avoiding possible allergic reactions. The system may connect to microbiome testing equipment and adjust the nutrient scores of the nutrient plan 324 based on the immediate results for illnesses and diseases such as inflammatory bowel disease, irritable bowel syndrome, ulcerative colitis, and Crohn's disease. The system may be capable of connecting to any peripheral hardware or software and adjusting the nutrient plan 324 based on the information gathered. The information may also be input manually by the user 302 or a medical professional through any computer, phone, watch, or any other device capable of receiving the manual input and storing a database or connecting to the system.

The user profile 304 also presents the nutrition plan 324 as recommended daily nutrition values 326. The nutrition plan 324 may be based on the account information of the user 302; specifically, the demographic, goal, and medical information. The nutrition plan 324, in the exemplary embodiment depicted in the user profile 304 in FIG. 3, presents the recommended daily nutrition values 326 and calls for 1,700 calories, 90 grams of protein, 60 grams or fats, and 200 grams of carbohydrates. The recommended daily nutrition values 326 may be based on the account information and may be updated or adjusted dynamically. The recommended daily nutrition values 326 may be met by supplying the nutrients 202 across the user preferred intake method. The user 302 preference is 3 daily meals and 2 daily snacks as seen in the food intake data 320. The preferred intake may also be decided by a medical practitioner or the system may learn and automatically update to provide the best results. The nutrition plan 324 may be a daily, weekly, or monthly plan and may be determined by the user 302 health information 322 and goal oriented data 318.

Though in the embodiment depicted in FIG. 3 the desired goal data 318 is described as weight loss, the user may input more specific goals. For example, the user may be on a particular diet. Many varieties of diet include limiting carbohydrates, fats, calories or any other nutrients. Some diets include increasing protein, vitamins and minerals, or any other nutrients. Some diets are time sensitive and require certain nutrients or foods for 10, 20, 30, or any number of days. These diets may be manually entered or may be accessed online and the system may include and adapt to any diet that may be chosen by the user 302.

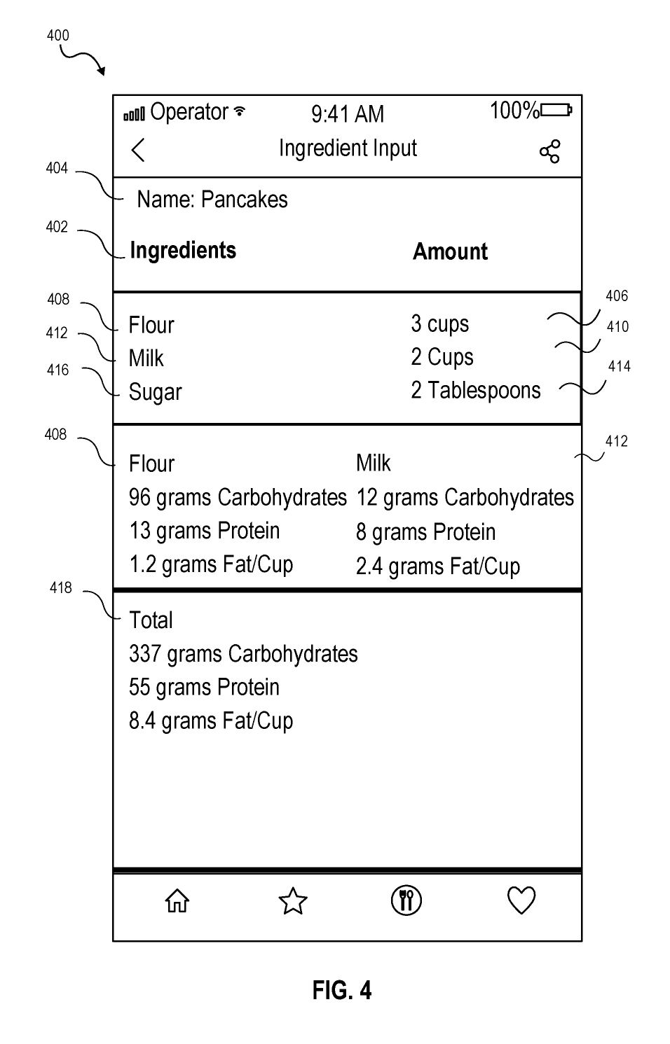

Once the user profile 304 is created and the recommended daily nutrition values 204 are known, meals may be scored relative to the daily nutrition plan 324. In embodiments, as depicted in FIG. 4, the ingredients for a meal may be entered into the system via the exemplary GUI 400 for evaluation and scoring. The ingredients 402 may be entered manually, a meal may be imaged, ingredient information may be retrieved online, or any other method of the system receiving information about a food may be used. Manually entering the ingredients 402 may be useful when following a recipe or creating a meal. For example, if the meal is pancakes 404, then the user may indicate that the recipe includes 3 cups 406 of flour 408, 2 cups 410 of milk 412, 2 tablespoons 414 of sugar 416, and so on. The information for each nutrient 202 in each ingredient 402 can be retrieved, scaled for the recipe and added to the total for the recipe. Nutrition information for individual ingredients 402 can be stored in the food database or retrieved from an online database such as that provided by the United States Department of Agriculture. Thus, for example, it might be determined that the flour 408 has 96 grams of carbohydrates, 13 grams of protein, and 1.2 grams of fat per cup, milk 412 has 12 grams of carbohydrates, 8 grams of protein, and 2.4 grams of fat per cup, and sugar has 12.6 grams of carbohydrates per tablespoon. This information (and the information for all other nutrients and ingredients 402 that may be present in pancakes 404) can be scaled and added to determine that the pancakes 404 have a total 418 of 337 grams of carbohydrates, 55 grams of protein, and 8.4 grams of fat per batch, and so on for each nutrient 202.

Continuing the example of pancakes 404 from above, the potential meal might include two of the sixteen pancakes produced by the recipe above, two strips of bacon (with 0.1 grams of carbohydrates, 3 grams of protein, and 3.3 grams of fat each), and 12 oz. of milk. The aggregate nutrient information for the potential meal would then be 60 g of carbohydrates, 25 grams of protein, and 11.25 grams of fat. In some embodiments, meals can be automatically scaled based on portion size information provided by a smart plate. For example, the weight of a portion can be determined and used to scale the portion. Though a smart plate is used in this exemplary embodiment a smart fork, spoon, bowl, measuring device, or any other appliance, or utensil that may record, retrieve, or send information indicative of the amount of an ingredient or meal may be used. One of skill in the art will appreciate that, while the above example has been described with reference to macronutrients, the same procedure can be followed for all of the nutrients including micronutrients (vitamins and minerals) to be considered by the system. Similarly, samples of prepared foods can be analyzed with a nutrient test kit to determine macronutrient and micronutrient information.

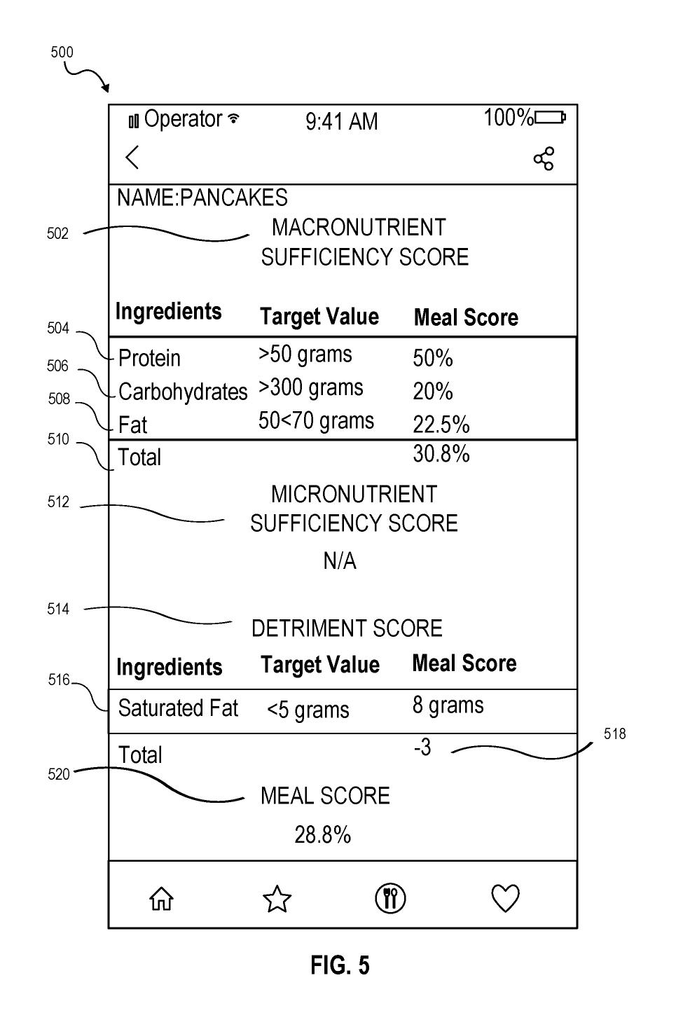

Turning to an exemplary GUI 500 in embodiments of the invention depicted in FIG. 5, once the aggregate nutrient information has been determined for each meal, the meal can be scored. The macronutrient sufficiency score 502 may be calculated. In some embodiments, subscores are first generated for each nutrient. For example, in the embodiment depicted in FIG. 5, assuming the target value for protein 504 for the user is “at least 50 grams,” the target value for carbohydrates 506 is “at least 300 grams” and the total value for fat 508 is “between 50 and 70 grams” then the breakfast described above would receive a protein 504 sufficiency score of 50%, a carbohydrate 506 sufficiency score of 20%, and a fat 508 sufficiency score of 22.5%. These values can then be blended (for example, averaged) to determine a total macronutrient sufficiency score 510 of 30.8%, if the average is used. Although the example above scales the various nutrients linearly, one of skill in the art will appreciate that this may not be the case; rather, it may be a more sophisticated calculation based on deficiency distribution or even deficiency distributions with modifications based on supplementary research. Or more sophisticated yet, the scores may be based on deficiency distributions, user 302 preferences, daily, weekly, or monthly activity including expected activity to preemptively provide necessary nutrients for optimal exercise.

Alternatively, daily values 204 or target values can be apportioned to individual meals. For example, instead of calculating sufficiency values for an entire day, the user may specify (or the system may automatically determine) that daily values 204 or target values should be apportioned 30% to breakfast, 30% to lunch, and 40% to dinner. Thus, instead of the sufficiency values calculated above, the system might calculate a breakfast carbohydrate sufficiency value of 66.7%, a fat sufficiency value of 75%, and a protein sufficiency value of 166.7%. In some embodiments, sufficiency values are capped at 100% instead. These values can then be blended as described above for each meal to meet the requirements of a broader timeline.

Micronutrient sufficiency scores 512 may be calculated next. As described above with respect to macronutrients, the values for the other nutrients (such as vitamins, minerals, water, fiber, essential fatty acids, amino acids, and other nutrients that are not macronutrients) provided by each potential meal can be calculated compared against the target values for the respective nutrients and blended as described above. In some embodiments, or for some meals, micronutrient information may not be available. For example, a restaurant may provide a macronutrient breakdown for their meals, but not micronutrient content. In such cases, the micronutrient sufficiency score 512 calculation step may be omitted and a limited meal score presented to the user 302 that does not include micronutrient information. As described above with respect to macronutrients, micronutrient sufficiency score 512 may be calculated for a day, an individual meal, or over a longer time period such as a week or month.

Next, detriment values may be calculated. Broadly speaking, detriment values can be assigned for any property of a meal that makes it undesirable. For example, exceeding a target value for a capped nutrient may cause a detriment value to be assigned. Thus, for example, if a meal would exceed the target value for total caloric input (for the day or for a particular meal), then a detriment value may be assigned. As described above, some nutrients (such as trans fats or added sugars) may have a target value of zero, so that a meal including any of those nutrients will have an associated detriment.

Continuing with the exemplary embodiment depicted in FIG. 5, detriment scores 514 may be calculated based on an overage amount (for example, if a meal contains 127% of the target value for saturated fat, it may be assigned a detriment of 27%) or a fixed detriment per amount of the undesirable nutrient (for example, 1% detriment for each gram of trans fats). For example, in the embodiment depicted in FIG. 5, 8 grams of saturated fats 516 are 3 grams over the recommended target value or limit of 5 gams. The total detriment score 518 may be −3. The total detriment score 518 may also be represented as a percentage as described in the macronutrients section above.

In embodiments, the overall score for the meal, or the meal score 520, may be calculated and presented to the user 302. As with the individual subscores calculated above, the macronutrient score 502, micronutrient score 512, and detriment scores 514 can be aggregated in a variety of ways to arrive at a final meal score 520. For example, the detriment subscore can be subtracted from the sum of the macronutrient and micronutrient subscores to determine the final meal score 520. Alternatively, the sum of the macronutrient score 502 and micronutrient scores 512 can be divided by 100% plus the detriment score 516. Other aggregation metrics are also contemplated as being within the scope of the invention. For example, a dietician may provide a scoring algorithm or set of scoring weights for an individual or for a life stage group that can be used instead of the more broadly applicable calculations described above. Once calculated, the final meal score 520 (alone or in combination with the component subscores) can be displayed to the user 302 via the GUI 500. In some embodiments, the user 302 can mark one of the potential meals as chosen (i.e., indicate what they have eaten) to allow the system to adjust target values to reflect what the user has consumed. In yet other embodiments, the system may present meals based on future exercise or activity that the user 302 may have stored in a calendar or a stored record of the user 302 typical activities and preferences.

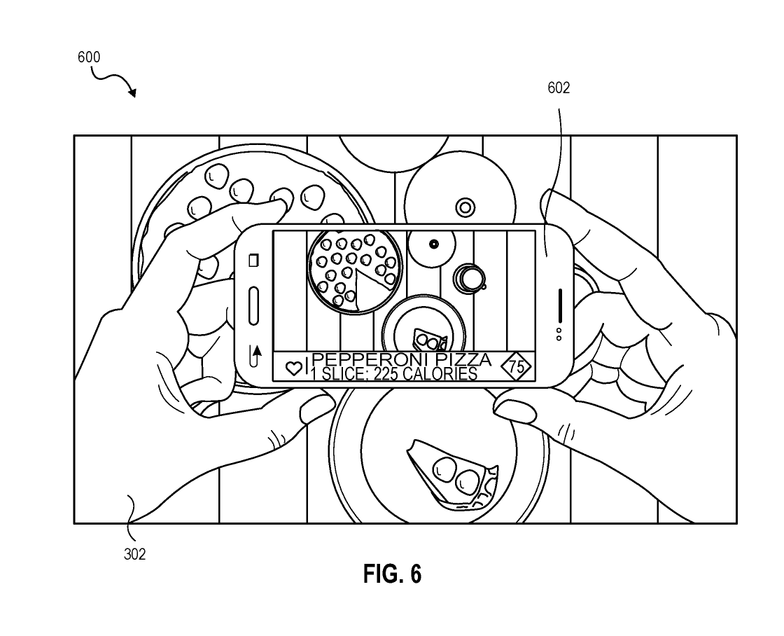

In an exemplary embodiment depicted in FIG. 6, the user 302 may have embodiments of the invention accessible on a mobile device 602 such as a phone, tablet, watch, or any other mobile device 602 that may contain the functionality to operate the GUI. The system may process information online anywhere that Wi-Fi or satellite reception is available or may access an internally stored database. For example, the system may be used in a restaurant.

As depicted in FIG. 6 the user 302 may use the system GUI 600 in conjunction with the mobile device 602 functionality such as a camera or video to image a meal. The system may have image recognition technology and access either a mobile device 602 stored database or an online database to process the image data and determine the image that has been captured by the mobile device 602. It is determined that the image is of pepperoni pizza. Once confirmed by the user 302 that the image is correctly recognized, the image may be stored in the database for future food recognition. The food and ingredients may also be input manually or selected from possible images as the system may provide multiple options if the image recognition software finds multiple similar images.

In some embodiments, the user specifies one or more potential meals. In other embodiments, potential meals can be automatically recognized by, for example, using machine-learning techniques to recognize a picture of the potential meal captured by the user. In still other embodiments, potential meals can be recognized by performing text recognition on a menu, by downloading a digital restaurant menu, or by scanning a barcode associated with a pre-packaged meal. The system may access the mobile device 602 GPS position and determine that the user 302 is at a restaurant and narrow the image searching based on the location. Broadly speaking, any technique for recognizing a potential meal is contemplated as being within the scope of the invention. Further, any hardware or software that may provide information to any condition of the user 302 that may adjust the nutrient plan 324 dynamically and any hardware or software that may order the food containing the nutrients provided in the nutrient plan 324 may be connected to and implemented by the system.

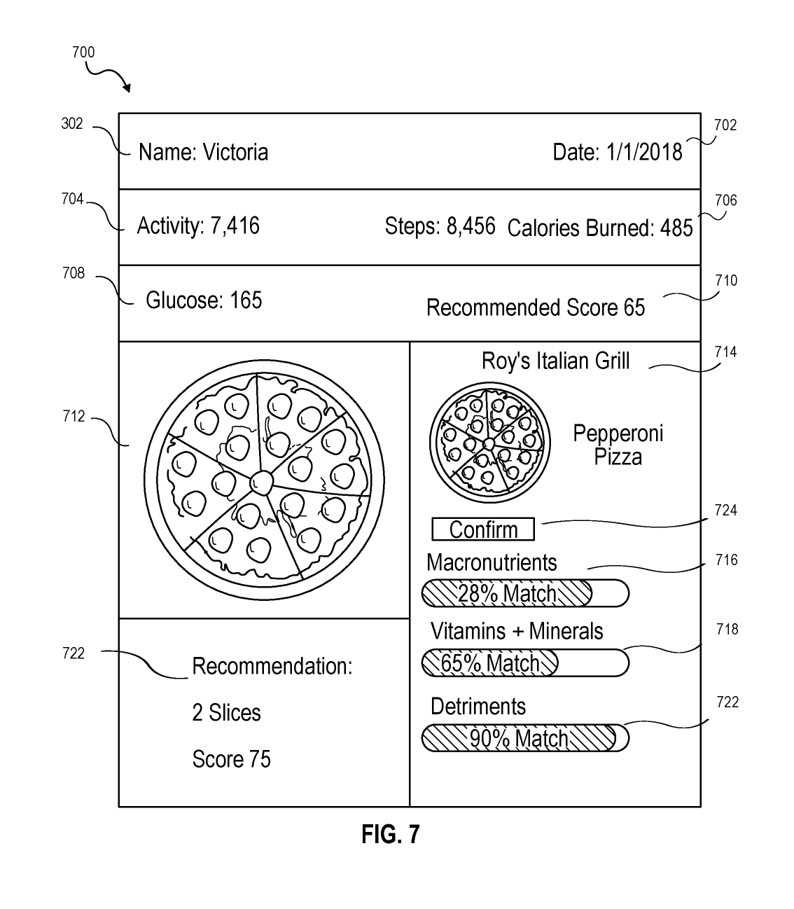

As depicted in the exemplary embodiment depicted in FIG. 7, the user 302 may also select an image provided by the system from the restaurant's online website. For example, the user 302 may enter a restaurant and the system may access a mobile device 602 GPS and determine that the user 302 has entered the restaurant. The system may access the restaurant's online menu to compare the images received from the mobile device 602 functions and provide a calculated score of the food in the image. Alternatively, the system may access the menu, calculate a score for each menu item and send a list of suggestions along with the menu item scores.

Turning now to FIG. 7, depicting an exemplary embodiment of a GUI 700 of the invention in which the image taken in the embodiment depicted in FIG. 6 is uploaded for evaluation by the system. On the GUI 700 is a user 302 name Victoria and the date 702. The date 702 is listed as any interactions and food consumed or imaged may be stored and associated with the date 702. Each meal may be automatically or manually saved on a calendar for each date 702 for tracking by the user 302 or the system. The system may use this information to build user 302 tendencies or score meals based on future expected user 302 activity.

The user activity 704 and steps and calories burned 706 for the day may also be displayed. This may also be activity for the week or month as, in embodiments, the GUI 700 may be customizable. The activity 704 may be entered manually by the user 302 or may be accessed from a peripheral device such as an activity tracker like a watch, wrist band, mobile phone, elliptical or any other device that the user 302 may wear or user that may track steps, heart rate, or any other movement that may be used to monitor activity. Information from exercise machines may also be received, displayed, and used to calculate activity 704, calories burned 706, and nutrient needed information, detriment, and recommended food scores 710. The activity 704 information may be retrieved through wired or wireless communication. The recommended score 710 may be a minimum score and a maximum score may be set at, for example, 100.

The user 302 medical information may also be used by the system. The medical information in the embodiment depicted in FIG. 7 is the user glucose levels 708. The glucose levels 708 may be accessed from a glucose monitor worn by the user 302. The glucose levels 708 may also be input manually. Other medical information such as cardiovascular information, blood pressure, temperature, DNA genome, microbiome-specific data, known or suspected allergies, or any other medical information that may be associated with a medical condition of the user 302 may be used.

Meal associated information 712 may display the image of the meal that is chosen by the user 302 for the system to determine the score 65 or the meal associated information 712 may display a meal suggested to the user by the system. The suggestion may come from an online website for the restaurant. In the embodiment, the user has imaged the meal and the image recognition software has determined that the imaged meal is pepperoni pizza from Roy's Italian Grill 714. The determination of the imaged food may be from the image recognition software only or may be a combination of the user's location drawn from a mobile device and image recognition software as described above. The GUI 700 may also present the scoring characteristics to the user 302. The meal macronutrients 716, vitamins and minerals 718, and detriments 720 may be presented. The overall score 722 for the meal or a recommendation that gives a score 722 within the recommended range may also be presented to the user. The score 722 may be based on the macronutrients 716, micronutrients 718, and the detriments 720 as described above. The user 302 may confirm 724 that the image is correct and may also confirm that the meal is the one selected and consumed by the user 302. The information may be updated in the user's 302 meal calendar manually or automatically.

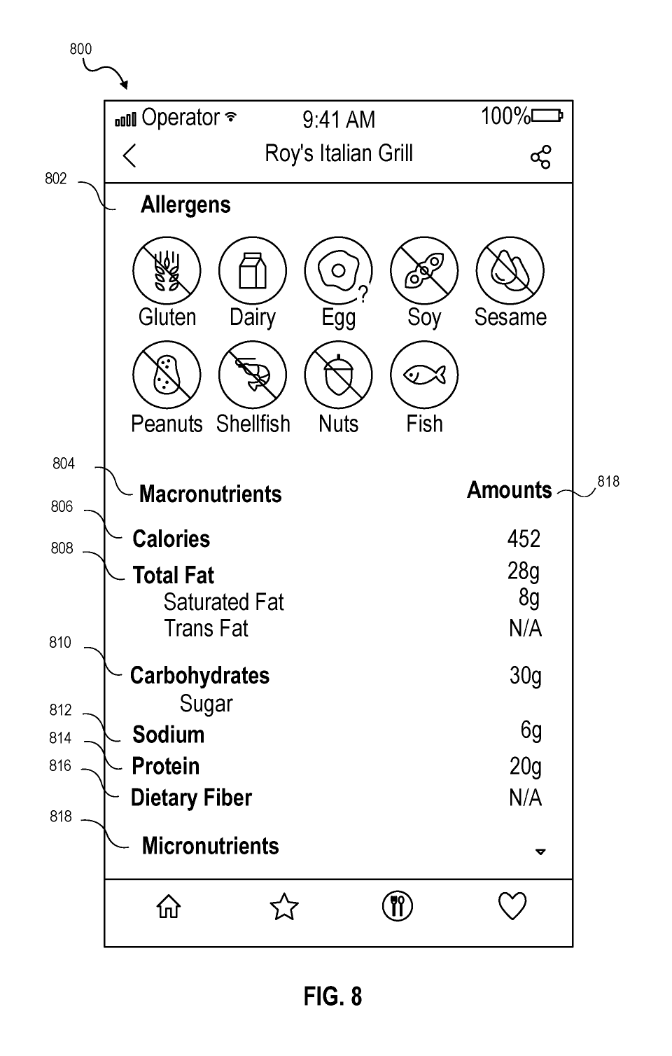

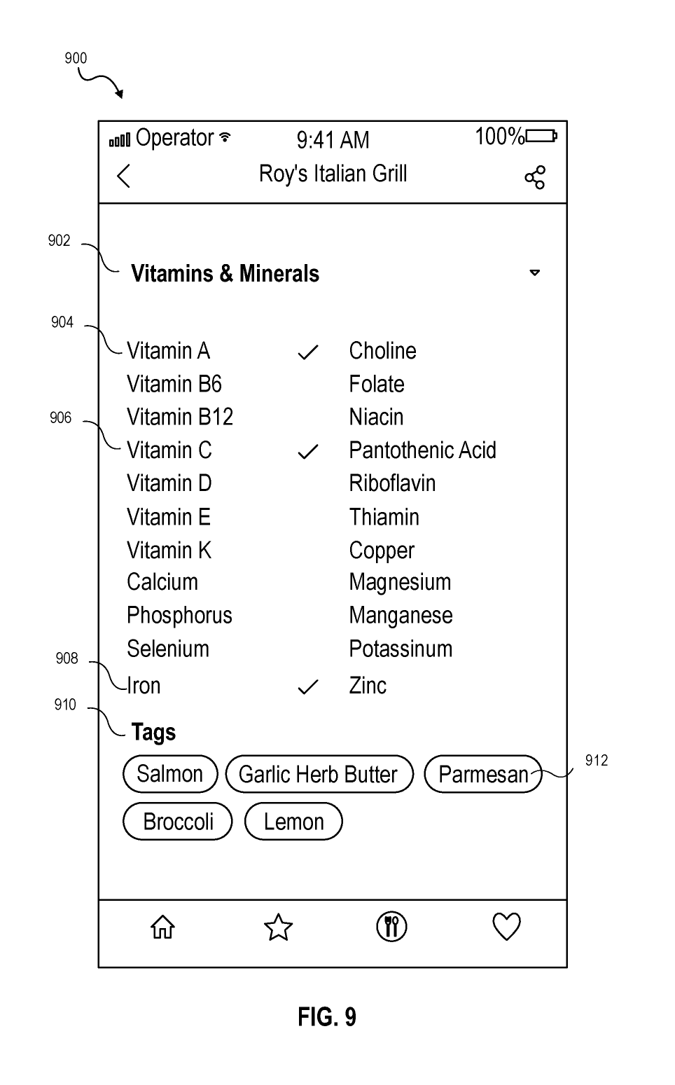

The user 302 may also be presented with a further breakdown of the meal as depicted in FIGS. 8 and 9. FIGS. 8 and 9 present a representative GUI 800 of an embodiment of the invention displaying Allergens 802 and Macronutrients 804. The presentation options are not limited and may provide the user with any information about the meal.

The Allergens 802 section may display the known allergens 802 in the meal. The meal of the embodiment contains dairy, fish, and possibly egg. If the user 302 is allergic to eggs then this alerts the user 302 that the user 302 may inquire further as to whether egg is in the meal. If the user 302 is lactose intolerant then the user 302 may choose other options or see if the restaurant has replacements. All the fields of the GUI 800 are manually customizable and may be updated by the user 302. For example, if dairy is removed from the meal, the user 302 may update the GUI 800 and the corresponding nutrients and scores may update automatically or manually.

The next section presents the macronutrients 804. Calories 806, fat 808, carbohydrates 810, sodium 812, protein 814, and dietary fiber 816 are displayed, but any macronutrients 804 contained within the meal may be displayed. The amounts 818 and scores (not shown) for each of the macronutrients 804 for a given meal or at any given time based on the dynamically updated user profile may also be presented via the GUI 800.

Turning to the continuing embodiment depicted in FIG. 9, the list of vitamins and minerals 902 may also be presented in the meal breakdown. In the embodiment, Vitamin A 904, Vitamin C 906, and Iron 908 are provided by the meal. In embodiments, the list of vitamins and minerals 902 may also provide the amounts of the vitamins and minerals 902 as in the previous macronutrients 804 section. In embodiments, the detriments may also be presented in the meal breakdown. The scores for each of the micronutrients and detriments for a given meal or at any given time based on the dynamically updated user profile may also be presented.

Another section in the meal breakdown may be Tags 910. The Tags may be a list of ingredients or components to a meal. The list of ingredients may be accessed from a stored or online database or may be from the restaurant's online menu. The macronutrients 804 and vitamins and minerals 902 list may be taken from the components in the Tags 910 section. The user 302 may add or delete any Tags 910 as the meal is changed. The user 302 may select each ingredient or component and be presented a further breakdown of the nutrients and detriments in each ingredient. This may provide the user 302 with further information for better selections. For example, after selecting and looking through the ingredients, the user may see that parmesan 912 provides high calories to the dish. The user 302 may decide that parmesan 912 is not worth the number of calories and elect to have this ingredient excluded from the dish. The user 302 may then remove the ingredient from the list and the scores may be adjusted accordingly.

The user 302 may be presented the meal breakdown to make an informed decision or to review past meals from the user 302 meal calendar to make more informed decisions in the future. For example, the user 302 may select a meal with broccoli however upon review of the calendar and the recommended nutrients it is seen that the nutrients provided by broccoli are in abundance and the vegetable should be substituted for a fruit based on user 302 planned future activity that the system does not have stored. The user proceeds to substitute an apple and the daily nutritional value changes.

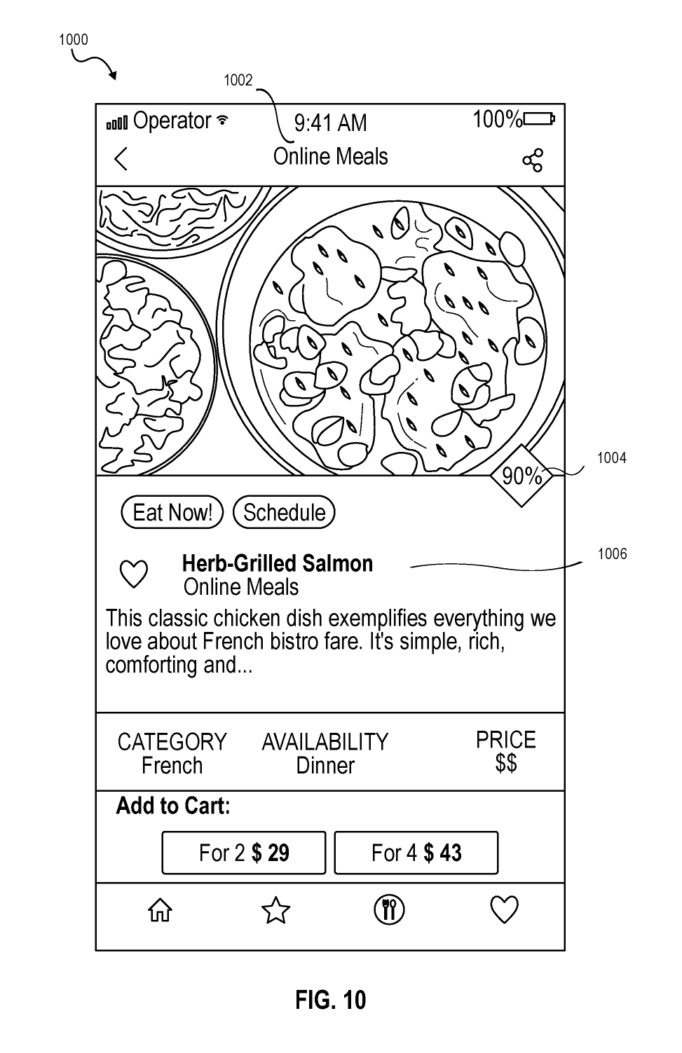

Turning now to an exemplary embodiment depicted in FIG. 10. The GUI 1000 may connect the user 302 with online meal plans. An exemplary company named Online Meals 1002 may deliver full meals to the user 302. The meals may be selected based on the dietary restrictions of the user 302 and the score 1004 provided to each meal by the system. The system may score 1004 each meal and recommend meals based on the scores 1004 and dietary restrictions. As depicted the Herb-Grilled Salmon 1006 has been given a score 1004 of 90%. Further, the GUI may present the breakdown of the meal as shown in FIGS. 8 and 9. The GUI may provide functionality for selecting and purchasing the meals through the website or a downloaded application for Online Meals 1002.

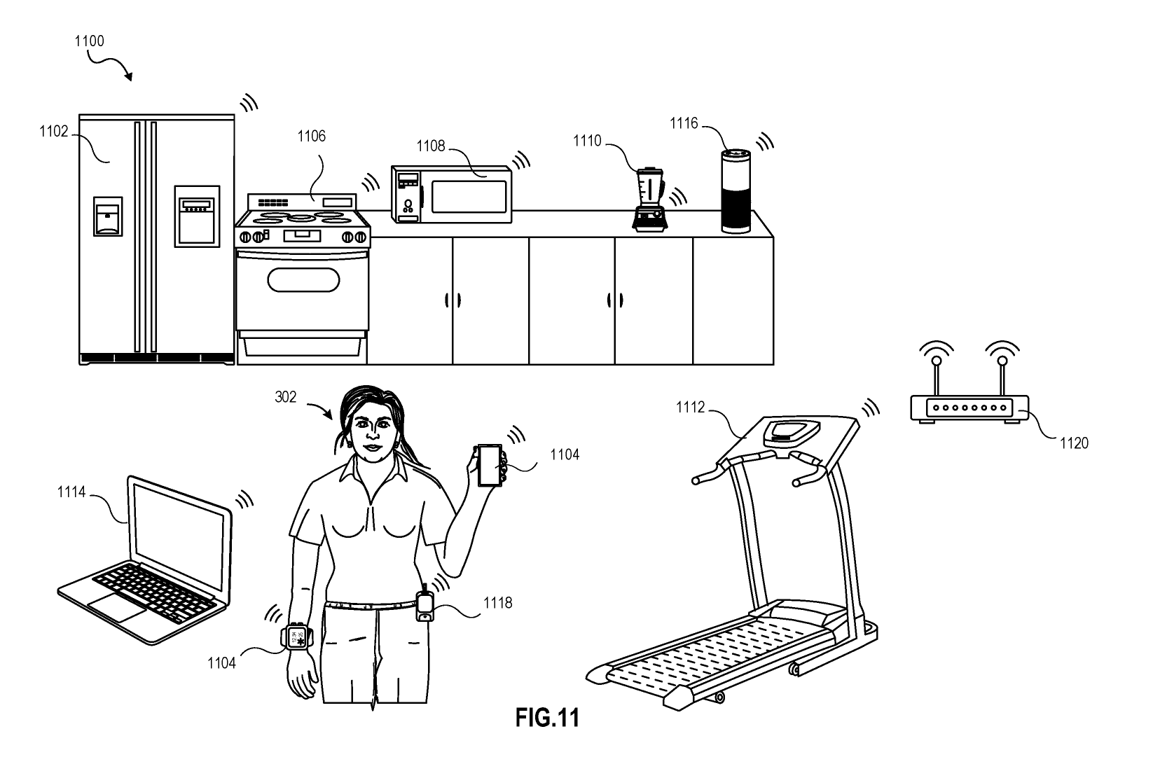

Turning now to an exemplary embodiment of a smart kitchen 1100 depicted in FIG. 11. The Online Meals 1002 purchased in the previous embodiment and other groceries may be stored in a smart refrigerator 1102. The meals and ingredients in the refrigerator 1102 may be stored in the refrigerator memory and may be accessed remotely by a mobile device 1104. The system may be stored on or accessed through the refrigerator 1102 and may provide meal recommendations based on the ingredients and nutrients in the meals in the refrigerator 1102. The meals and ingredients selected by the user may also be input into the system via the refrigerator 1102 and the system updated with the information to provide new nutrient recommendation scores for all possible meals in the refrigerator 1102 dynamically based on user 302 activity, diet information, and preferences.

Continuing with the exemplary embodiment depicted in FIG. 11, the system may be connected to any kitchen smart appliance such as an oven 1106, microwave 1108, blender 1110, a smart television (not shown), or any other type of kitchen or non-kitchen appliance or electronics that may access the internet. For example, a treadmill 1112 may send information related to a user 302 exercise routine. The system may then access the refrigerator 1102 ingredients and recommend a high protein meal. The user 302 may customize the system content such that when an exercise such as using the treadmill 1112, or jogging, is performed the system provides shake options. The options may be provided based on the contents of the refrigerator 1102 and further based on a diet that the user 302 is on. Once the exercise is finished, the user 302 may access the GUI 1100 on a laptop computer 1114, or mobile device 1104 such as a smartphone, or the refrigerator 1102 and view the recommendations. The GUI 800 may display an option for a strawberry banana shake with kale. The shake has been given a score of 75 and is not only based on the subscores for macronutrients, micronutrients, and detriments, but may also be based on a recorded history of the user's 302 choices. This may provide the user 302 with selections that the user 302 prefers. The user 302 may also rate the meals and shakes such that the system may “learn” what the user 302 prefers and include this in the recommendations. The user recommendations, ratings, and preferences may be stored for restaurants as well, and may be applicable to any embodiments of the system.

The system content may be accessed through all appliances, activity trackers, mobile devices 1114, or any intelligent personal assistant hardware such as a mobile personal assistant (e.g., Apple® HomePod, Google® Assistant, or Amazon® Echo) or, for example, an online voice activated device 1116. The online voice activated device 1116 may be used to update or customize the system. For example, the user 302 may select a meal from the refrigerator 1102 and the system may be automatically updated and the list of ingredients on a grocery list stored on the online voice activated device 1116 may be updated based on the nutrients that the user 302 has consumed. The user 302 may also connect any list from the online voice activated device 1116 such that the user 302 may speak to the device and the list may be updated accordingly.

The grocery list stored on the system may also be connected to a grocery store online system and the list may be sent to the grocery store for curb side pick-up or a grocery shopping plan may be created based on the location of the list items within the grocery store. The system may be connected to any smart carts or aisles in the grocery store and may be accessible to the user 302 while shopping. Notifications or alerts may be sent to the user via the carts or displays in the aisles or via any personal mobile device of the user 302 when the user 302 is close to a list item within the store. The system may either alert or order any food item that may be on the grocery list as determined by the nutrient plan 324. Alternatively, data provided by such smart carts may be used to provide nutrient information, ingredient information, or to suggest meals to the user.

The system may also send information to the online voice activated device 1116 automatically. Recommended meals, ingredients, sufficiency or detriment scores, or the user nutrient or medical information may be provided to the user 302 via the online voice activated device 1116. For example, the user's 302 glucose levels may be low. The system may recognize the low glucose levels on the glucometer 1118 that may be attached to the user 302 and alert the user 302 via the online voice activated device 1116 automatically with meal recommendations such as a snack to reduce the glucose levels. In other embodiments, the user 302 may exercise on the treadmill 1112 as described above and the voice activated device 1116 may provide meal, shake, or snack recommendations as supplied via the system based on the exercise and the refrigerator 1102 contents. The recommendations may also be supplied to the user 302 via any embodiment of the GUI 1100 on any one of the mobile devices 1104, appliances, or computers described above. The system may connect with any devices in the smart kitchen 1100 and may be wired, wireless or connect over a network 1120.

Data from body worn peripheral devices such as the glucometer 1118, and the mobile devices 1104 may be used in any embodiment of the invention. For example, if a user 302 has a fitness band that tracks their activity level, then the total caloric intake for the day can be adjusted based on how much energy the user 302 has expended. Similarly, if the user's 302 blood pressure is elevated, then the recommended intake of sodium can be reduced. Any biometric data can be used to adjust the target values. For example, if the user is diabetic and monitors their blood sugar levels periodically or continuously, then the target values for simplex and complex carbohydrates can be adjusted on the fly to maintain an optimal blood sugar level. Galvanic skin response can be used to determine the user's hydration level, which can in turn be used to adjust the target value for water. Respiration rate and history, perspiration, body temperature, or any other biometric measurement, now known or later developed, can also be used to adjust the dynamic user profile.

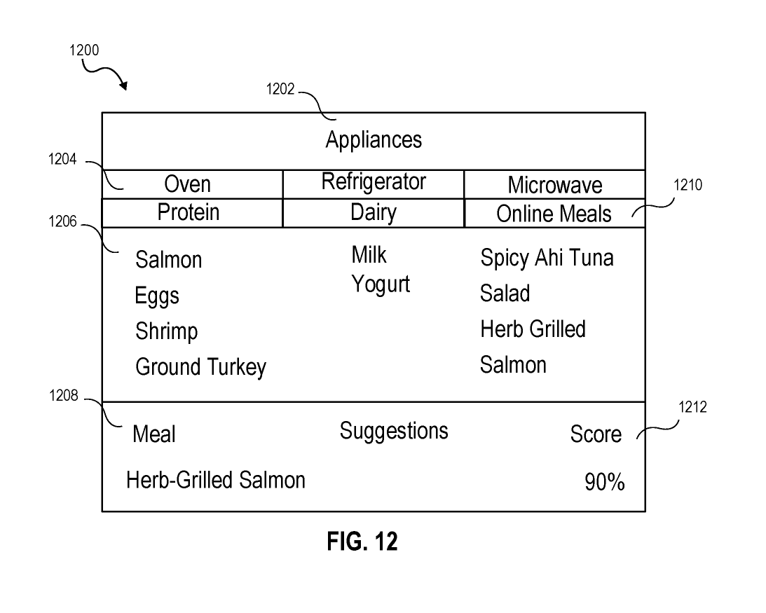

Turning now to the exemplary GUI 1200 depicted in FIG. 12. The system may access the information stored on the many peripheral devices and the smart kitchen appliances as described above. The exemplary embodiment in FIG. 12 depicts the GUI 1200 presenting access to the kitchen smart appliances of FIG. 11. The appliances 1202 may automatically be accessible since they may be in wireless communication. The user 302 may select an appliance 1202 then proceed to view the food that may be available within the appliance 1202. For example, the refrigerator may be selected and the online meals section may be selected beyond that. The user may select Herb-Grilled Salmon and the system provides the score for the Herb-Grilled Salmon.

The user 302 may also manage the appliances 1202 from the GUI 1200. For example, the user may place ingredients for a shake in the blender 1110. The user 302 may then exercise. The mobile device 1104 may recognize that the user is finished with the exercise and automatically send a signal via the system to start the blender 1110 and prepare the shake. Alternatively, the user 302 may arrive home from work and a sensor on the door alerts the system that the user 302 is home. The daily activity for the user has been recorded and the nutrient sufficiency scores are known. The system may score the items in the refrigerator 1102 and may alert the online voice activated device 1118. As the user 302 enters, the online voice activated device 1118 may alert the user 302 as to what is for dinner as well as provide the ingredients and the sufficiency scores. The settings may be stored on the devices and input via the GUI 1200.

The system may also calculate the score for all ingredients 1206 that may be present in an appliance 1204 and provide the user with scores and meal or snack recommendations 1208. For example, the system may be presented with Spicy Ahi Tuna Salad and Herb-Grilled Salmon from the Online Meals 1210 section in the GUI 1200. The Spicy Ahi Tuna Salad may have a score of 74 while the Herb-Grilled Salmon has a score 1212 of 90. The system then may recommend the meal with the higher score, i.e. the Herb-Grilled Salmon.

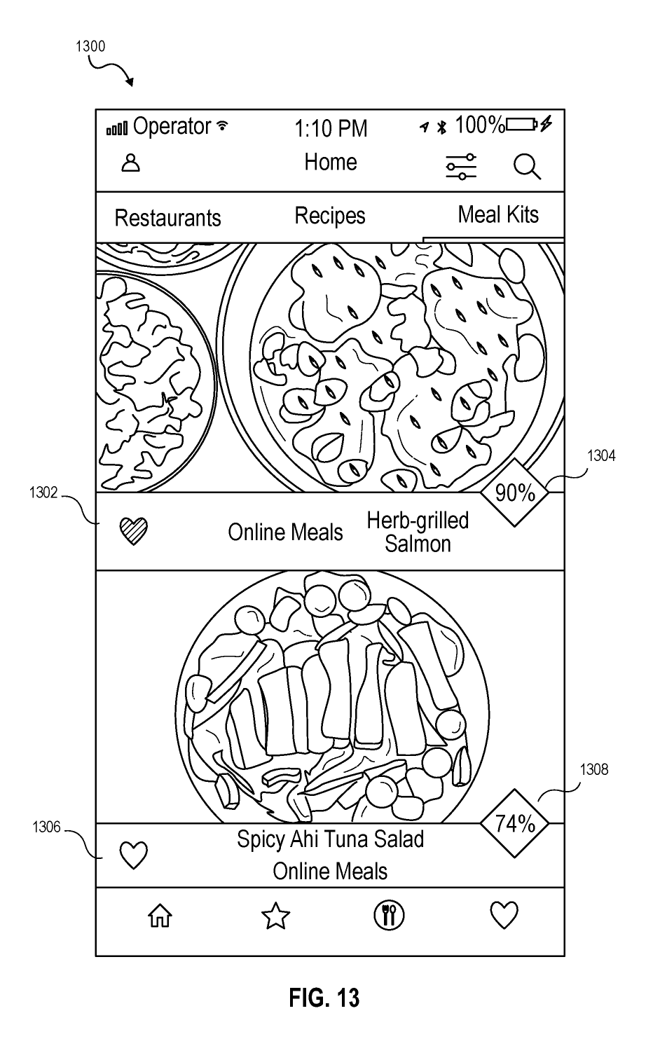

Turning now to an exemplary GUI 1300 depicted in FIG. 13. The system may provide two meal options that have high sufficiency scores; the Herb-Grilled Salmon 1302 with a score of 90% 1304 and the Spicy Ahi Tuna Salad 1306 with a score of 74% 1308. The system may provide scores for meals based on demographic data, biometric data, exercise, and any other data associated with the user 302, but, in embodiments, the system may also provide scores based on future data. For example, the GUI 1300 may be providing meal options for lunch on Wednesday. The system, through machine-learning, neural networks, or statistical algorithm, may provide a probability that the user 302 will exercise on Wednesday afternoon. This may be calculated from history or a schedule such as a calendar. It also may be determined that with a certain probability the user 302 may do a particular exercise such as jogging. The expected calories burned and nutrients that may need replenishing may also be predicted. The meals recommended for lunch may be based on past information but also expected future activities. This future prediction may help the user 302 stay healthy and meet goals.

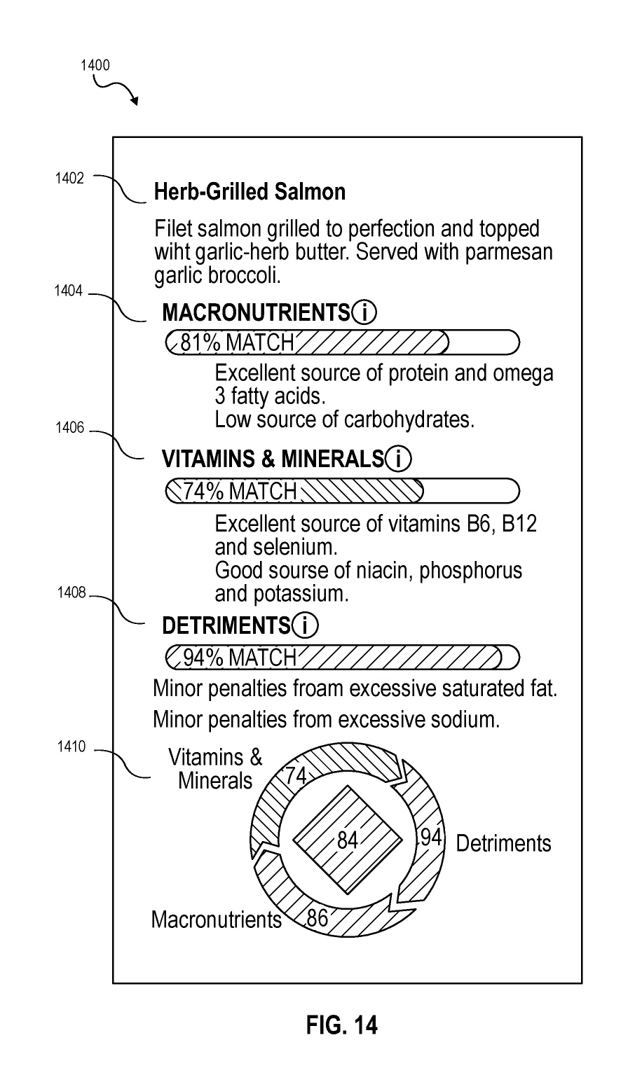

Turning now to an embodiment depicted in FIG. 14 of a GUI 1400 presenting the nutrient breakdown for the Herb-Grilled Salmon 1402. The breakdown may include macronutrient sufficiency score 1404 of 81%. A Vitamins and Minerals score 1406 of 74% and a Detriments score 1408 of 94%. Each score may also provide an explanation of the score such that the user 302 may more easily follow the scoring and track meals. The score breakdown may also be provided in a pinwheel manner as displayed in the lower section 1410. This visual may make it easier for the user to instantly understand the structure. In embodiments, the scores may be displayed in a bar graph, line graph, or any way that may be easily understandable to the user 302. The system may also track changes and all histories of the user health and scores and may be presented to the user in any manner that may be easily understood. In embodiments, the system may track health history from on online database and may update health information such that it may be accessible and edited by a health practitioner.

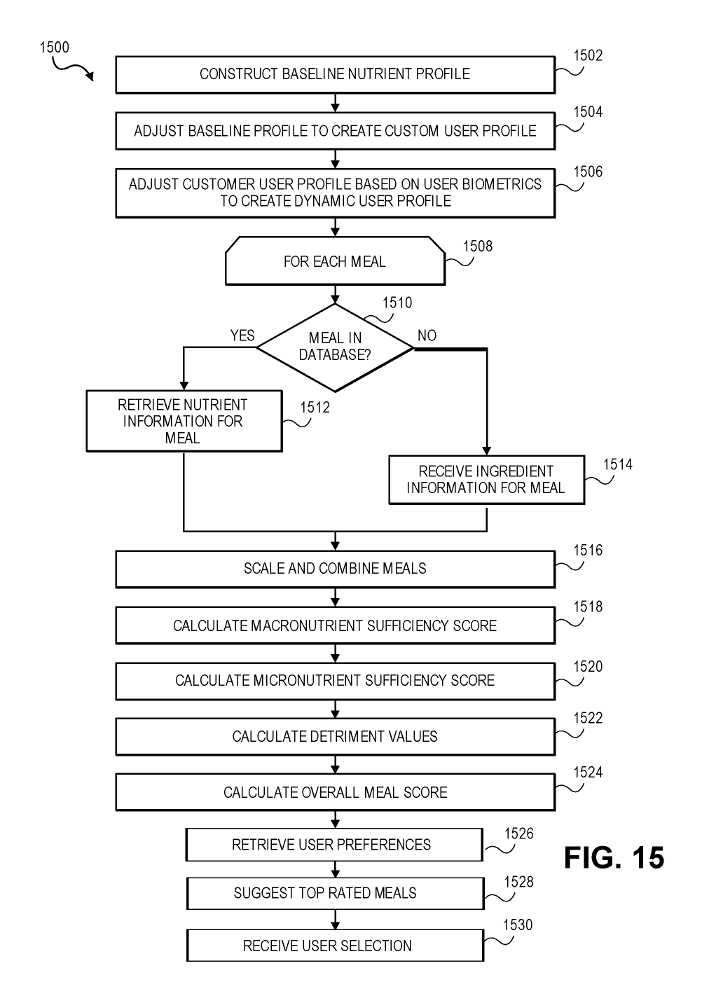

Turning now to FIG. 15. A flowchart illustrating the operation of a method in accordance with embodiments of the invention is depicted and referred to generally by reference numeral 1500. The method begins at step 1502, where a baseline nutrient profile for a user is constructed. The baseline nutrient profile may be a starting point for all users that may be generally constructed from a standard nutrient chart as provided by, for example, the United States Food and Drug Administration.

Once the baseline nutrient profile for the user has been constructed, processing can proceed to step 1504, where the baseline nutrient profile is adjusted based on user demographic data to create the custom user profile. The nutrient profile may be adjusted based on a user's height, weight, age, sex, diet, goals, genetics, or any other user characteristic that may influence the kind of nutrients or the amount of nutrients to be consumed by the user.

In some embodiments, processing can then proceed to step 1506, where the custom user profile can be dynamically adjusted based on user biometrics to form the dynamic user profile. The dynamic adjustment may be caused by nutrient intake, user activity, medical procedures, medical practitioner input, or any other input that may influence the recommended nutrient intake of the user. The system may receive the inputs manually or automatically through an activity tracker such as a watch, wristband, mobile device, treadmill, elliptical or any other device that may monitor activity, or health monitor such as a glucometer, blood pressure meter, galvanometer, or any other device that may be used to track the user's health.

Processing can then proceed to loop 1508, where steps 1510 through 1530 are repeated for each potential meal to be scored. The potential meals may be provided by the user or automatically retrieved online. The potential meals may be based on history or future expected activity by the user. The potential meals may also be provided by a restaurant, stored in a user's kitchen, or provided as a recommendation based on the user preferences or tracked history calculated probability of the user's actions.

For each potential meal, loop 1508 begins with decision 1510, where it is determined whether each food making up the meal is stored in the food database. If so, processing proceeds to step 1512; otherwise, processing proceeds instead to step 1514. At step 1512, nutrient information for the food is retrieved from the food database. Broadly speaking, the food database allows certain foods to be stored as a whole without the need to score individual ingredients. In some embodiments, restaurant meals are stored in the food database based on published nutrition information. Homemade foods that the user has previously prepared may also be stored in the food database to remove the need for the user to re-enter food details. If the food is not stored in the food database, processing proceeds to step 1514, where the user can enter ingredient information for the food or the system may access online information about the possible food such as online menus and recipes.

From step 1512 or step 1514, processing proceeds to step 1516, where meals are scaled and combined. In embodiments, any of the components of a meal may be measured or scaled and combined with the other components of the meal to create a combined meal score.

Once the aggregate nutrient information has been determined for each meal, the meal can be scored. This process begins at step 1518, where the macronutrient sufficiency score is calculated. In some embodiments, subscores are first generated for each nutrient. Macronutrient sufficiency values may be calculated for a recommended daily nutrition plan and may be broken into meals and snacks or into any manner that may be preferred by the user.

Processing can then proceed to step 1520, where micronutrient sufficiency scores can be calculated. The micronutrient score may be calculated similarly to the macronutrient score.

Next, processing continues to step 1522, where detriment values are calculated. Detriment values may be assigned to any meal or ingredient that may make it undesirable such as exceeding a target value or having little to no need in the recommended daily nutrition plan.

Processing can then proceed to a step 1524, where the overall score for the meal is calculated and presented to the user. As with the individual subscores calculated above, the macronutrient, micronutrient, and detriment scores can be aggregated in a variety of ways to arrive at a final meal score. Combining the ingredients into a combined meal score may simplify the process reduce the amount of time the user may spend tending to the diet.

Processing can then proceed to a step 1526, where the system may retrieve saved user preferences. The user preferences may help determine meals or snacks to recommend. In some embodiments, the meals may be based on user activity preferences.

Processing can then proceed to step 1528, where the system may recommend selected high scoring meals from a plurality of potential meals. The potential meals may be gather from an online menu or a grocery list in the user's home.

Processing can then proceed to step 1530, where the user profile and recommended daily nutrition plan is dynamically updated with the user selection. As the user makes a selection or edits any part of the daily nutrition plan the user profile and daily nutrition plan may automatically or manually update accordingly.

Any of the above steps of the exemplary flow chart 1500 depicted in FIG. 15 may be moved or omitted. For example, if the user is at a restaurant and presenting one meal option to the system for evaluation step 1528 may be omitted as the system does not provide recommendations based on a plurality of potential meals.

Any sections of any embodiment of a graphical user interface may be rearranged and may be customizable in any way. Any section may be omitted or added and any section may be rearranged with any other section or sections.

Many different arrangements of the various components depicted, as well as components not shown, are possible without departing from the scope of the claims below. Embodiments of the invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims. Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A method of determining a user-specific nutrition score for a meal, comprising the steps of:
determining a plurality of baseline recommended intake values for a plurality of nutrients,
wherein the plurality of nutrients includes a plurality of macronutrients and a plurality of micronutrients;
adjusting the plurality of baseline recommended intake values based on demographic information for the user to obtain a respective plurality of custom recommended intake values;
further adjusting the plurality of custom recommended intake values based on biometric data for the user to obtain a respective plurality of dynamic recommended intake values;
wherein the biometric data is obtained from a peripheral device;
determining, for a potential meal, nutrient content values for at least a portion of the plurality of nutrients;
calculating, based on the plurality of nutrient content values, the plurality of dynamic recommended intake values, and the condition of the user a macronutrient sufficiency score, a micronutrient sufficiency score, and a detriment score; and
calculating a meal score based at least in part on the macronutrient sufficiency score, the micronutrient sufficiency score, and the detriment score.

2. The method of claim 1, wherein the peripheral device is one of a health condition monitor or an activity tracker.

3. The method of claim 2, wherein the activity tracker is at least one of a wearable device or an exercise machine.

4. The method of claim 2, wherein the health condition monitor is at least one of a glucose monitor, heart monitor, or blood pressure monitor.

5. The method of claim 1, wherein the potential meal is selected from a plurality of potential meals from an online database.

6. The method of claim 1, wherein the potential meal is selected from a plurality of potential meals or ingredients provided by a smart appliance.

7. The method of claim 1, wherein the meal score is further based at least in part on user preferences.

8. The method of claim 1, wherein the macronutrient sufficiency score, the micronutrient sufficiency score, and the detriment score are based at least in part on expected future activity of the user.

9. The method of claim 1,
wherein information associated with the potential meal is received from a peripheral device, and
wherein the information associated with the potential meal is an image of the potential meal.

10. A system for determining a user-specific nutrition score for a meal, comprising:
a data store storing a plurality of baseline recommended intake values for a plurality of nutrients, wherein the plurality of nutrients includes a plurality of macronutrients and a plurality of micronutrients;
a processor;
a first peripheral device configured to gather biometric data from the user;
a second peripheral device configured to gather information associated with a potential meal;
one or more non-transitory computer-readable media storing computer-executable instructions that, when executed, perform the method of determining a user-specific nutrition score for a meal, the method comprising:
adjusting the plurality of baseline recommended intake values based on demographic information for the user to obtain a respective plurality of custom recommended intake values;
further adjusting the plurality of custom recommended intake values based on the biometric data from the user to obtain a respective plurality of dynamic recommended intake values;
determining nutrient content values for at least a portion of the plurality of nutrients in the potential meal;
storing the determined nutrient content values in the data store;
calculating, based at least in part on the plurality of nutrient content values, the plurality of dynamic recommended intake values, and the biometric data, a macronutrient sufficiency score, a micronutrient sufficiency score, and a detriment score; and
calculating a total score based at least in part on the macronutrient sufficiency score, the micronutrient sufficiency score, and the detriment score.

11. The system of claim 10, wherein the second peripheral device is a mobile device and the information associated with the potential meal is on online menu.

12. The system of claim 10, wherein the information associated with the potential meal is an image of the potential meal.

13. The system of claim 10,
wherein the potential meal is one of a plurality of potential meals, and
wherein the processor calculates scores for the plurality of potential meals.

14. The system of claim 13, wherein the second peripheral device is a mobile device and the plurality of potential meals are received from an online menu associated with the GPS location of the mobile device.

15. The system of claim 14, wherein at least one of the potential meals is recommended to the user via a graphical user interface generated by the processor.

16. The system of claim 10, wherein the first peripheral device is one of an activity tracker or a health monitor.

17. One or more computer-readable media storing computer-executable instructions which, when executed by a computer perform a method of determining a user-specific nutrition score for a meal, the method comprising the steps of:
determining a plurality of baseline recommended intake values for a plurality of nutrients,
wherein the plurality of nutrients includes a plurality of macronutrients and a plurality of micronutrients;
adjusting the plurality of baseline recommended intake values based on demographic information for the user to obtain a respective plurality of custom recommended intake values;
further adjusting the plurality of custom recommended intake values based on biometric data for the user to obtain a respective plurality of dynamic recommended intake values,
wherein the biometric data is received from a peripheral device;
receiving information associated with a potential meal;
determining, for the potential meal, using the information associated with the potential meal, nutrient content values for at least a portion of the plurality of nutrients;
calculating, based at least in part on the plurality of nutrient content values, the plurality of dynamic recommended intake values, and the biometric data, a macronutrient sufficiency score, a micronutrient sufficiency score, and a detriment score;
calculating a total score based at least in part on the macronutrient sufficiency score, the micronutrient sufficiency score, and the detriment score; and
recommending the potential meal to the user via a graphical user interface.

18. The media of claim 17, wherein the information associated with the potential meal is an image of the potential meal and received from a peripheral device.

19. The media of claim 18, wherein the peripheral device is a mobile phone and the information associated with the potential meal is a menu associated with the GPS location of the mobile phone.

20. The media of claim 17, wherein the peripheral device is one of a health condition monitor or an activity tracker.
